(19) United States
(12) Patent Application Publication
(10) Pub. No.: US 2025/0061495 A1
(43) Pub. Date: Feb. 20, 2025

(54) CALIBRATING EVALUATOR FEEDBACK RELATING TO AGENT-CUSTOMER INTERACTION(S) BASED ON CORRESPONDING CUSTOMER FEEDBACK

(71) Applicant: NICE LTD., Ra’anana (IL)

(72) Inventors: Rahul VYAS, Jodhpur (IN); LeAnn HOPKINS, Lake Worth, FL (US); Harsha MARSHETTIWAR, Nagpur (IN)

(21) Appl. No.: 18/450,797

(22) Filed: Aug. 16, 2023

(51) Int. Cl. G06Q 30/0282; G06Q 30/015; G06Q 30/0203

(52) U.S. Cl. CPC G06Q 30/0282; G06Q 30/015; G06Q 30/0203

(57) ABSTRACT

Apparatus, systems, and methods for calibrating evaluator feedback relating to agent-customer interaction(s) based on corresponding customer feedback. An agent evaluation form is generated based on customer feedback provided via a customer questionnaire. By comparing evaluator feedback received via completion of the agent evaluation form by one or more user-selected evaluators to the customer feedback provided via the customer questionnaire, a customer feedback variance score is calculated for the one or more user-selected evaluators.

### TECHNICAL FIELD

The present disclosure relates generally to calibrating evaluator feedback relating to agent-customer interaction(s), and, more particularly, to apparatus, systems, and methods for calibrating said evaluator feedback based on corresponding customer feedback.

### BACKGROUND

The calibration process is a process for rating and discussing customer service on a given channel (e.g., digital, telephony), and is important for ensuring that call center managers, supervisors, and quality-assurance teams are able to effectively evaluate agent performance and improve customer service. Currently, to initiate the calibration process, a manager or supervisor must select a single agent-customer interaction and assign it to a given set of evaluators for performance evaluation—this is a manual and time-consuming task, often resulting in missed or lost calibrations for a large number of agent-customer interactions. Moreover, quality-assurance teams are required to maintain a huge list of evaluation forms on which calibration must be performed—such forms often are not helpful in understanding the pain points provided by corresponding customer feedback. Therefore, what is needed are apparatus, systems, and/or methods that help address one or more of the foregoing issues.

### BRIEF DESCRIPTION OF THE DRAWINGS

FIG. 1A is a diagrammatic illustration of a system for calibrating evaluator feedback relating to agent-customer interaction(s) based on corresponding customer feedback, according to one or more embodiments of the present disclosure.

FIG. 1B is another diagrammatic illustration of the system of FIG. 1A, according to one or more embodiments of the present disclosure.

FIG. 2 is a diagrammatic illustration of a calibration configuration information table, according to one or more embodiments of the present disclosure.

FIG. 3A is a diagrammatic illustration of an example user interface relating to one or more customer feedback questions, according to one or more embodiments of the present disclosure.

FIG. 3B is a diagrammatic illustration of an information feedback form storable in a form database, according to one or more embodiments of the present disclosure.

FIG. 3C is a diagrammatic illustration of a customer feedback database in which customer feedback is storable, according to one or more embodiments of the present disclosure.

FIG. 3D is a diagrammatic illustration of a search application, according to one or more embodiments of the present disclosure.

FIG. 3E is a diagrammatic illustration of an interaction sampled segment database, according to one or more embodiments of the present disclosure.

FIG. 4A is a diagrammatic illustration of agent and evaluator priority tables, according to one or more embodiments of the present disclosure.

FIG. 4B is a flow diagram showing an agent segment assignment phase, according to one or more embodiments of the present disclosure.

FIG. 4C is a diagrammatic illustration of an evaluation task assignment database, according to one or more embodiments of the present disclosure.

FIG. 5 is a diagrammatic illustration of a formula used by a calibration calculation module of the system of FIGS. 1A and 1B to calculate a customer feedback variance score, according to one or more embodiments of the present disclosure.

FIG. 6A is a flow diagram of an algorithm for sending calibration(s) to a list of evaluators, according to one or more embodiments of the present disclosure.

FIG. 6B is a diagrammatic illustration of a user interface for a comparative calibration report, according to one or more embodiments of the present disclosure.

FIG. 7A is a diagrammatic illustration of an entire life-cycle of the algorithm shown in FIG. 6A, according to one or more embodiments of the present disclosure.

FIG. 7B is a diagrammatic illustration a cron-job application via which the entire life-cycle process shown in FIG. 7A can be run and scheduled, according to one or more embodiments of the present disclosure.

FIG. 8 is a diagrammatic illustration of an improvement in response time provided by the system of FIGS. 1A and 1B, according to one or more embodiments of the present disclosure.

FIG. 9 is a flow diagram of a method for calibrating evaluator feedback relating to agent-customer interaction(s) based on corresponding customer feedback, according to one or more embodiments of the present disclosure.

FIG. 10 is a diagrammatic illustration of a computing nod for implementing one or more embodiments of the present disclosure.

### DETAILED DESCRIPTION

The present disclosure introduces a process for calibrating agent-customer interaction(s), which process involves one or more agents (e.g., call center agent(s)), one or more corresponding evaluators (e.g., call center supervisor(s)), and one or more quality managers (e.g., quality monitoring vendor(s)). In one or more embodiments, the process introduced by the present disclosure helps to smoothly drive the evaluation and calibration of agent-customer interaction(s), utilizing customer feedback, without the overhead of maintaining, searching, and using a huge list of evaluation forms.

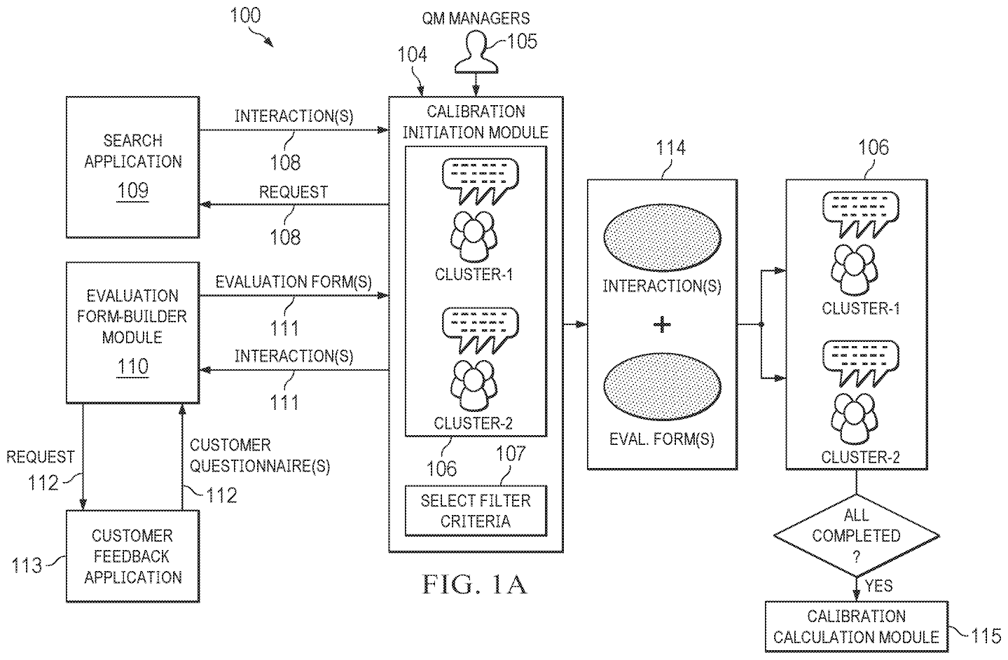

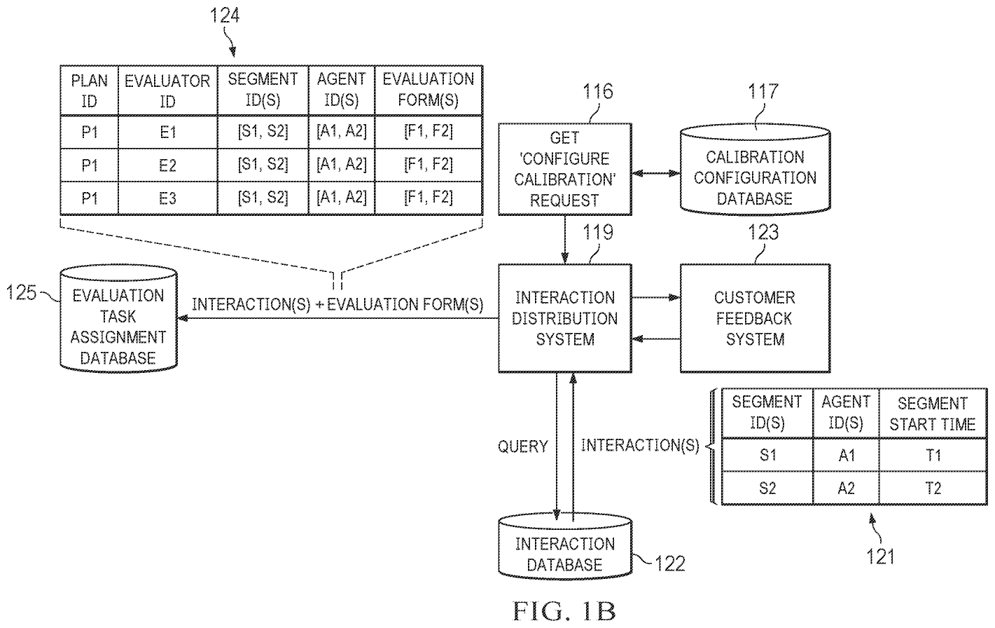

Referring to FIGS. 1A and 1B, a system 100 for calibrating evaluator feedback relating to agent-customer interaction(s) based on corresponding customer feedback is illustrated according to one or more embodiments. The system 100 includes a calibration initiation module 104, an evaluation form-builder module 110, and a calibration calculation module 115, as shown in FIG. 1A.

The calibration initiation module 104 enables one or more quality managers 105 (also referred to as “users”) to configure a calibration plan for one or more evaluators 106 by selecting the one or more evaluators 106 together with one or more filter criteria 107. Specifically, as shown in FIG. 1B, in response to getting a ‘configure calibration’ request 116 from the one or more quality managers 105, a calibration plan configurator is fetched from a calibration configuration database 117 and communicated to an interaction distribution system 119—in such embodiments, the calibration initiation module 104 is part of the interaction distribution system 119, and the one or more quality managers 105 configure the calibration plan using the calibration plan configurator communicated to the interaction distribution system 119. In one or more embodiments, the one or more filter criteria 107 include channel type (e.g., digital, telephony, etc.), duration of interaction, customer scoring of interaction, customer sentiment during interaction, the like, or any combination thereof.

The one or more filter criteria 107 form the basis on which one or more agent-customer interactions (e.g., one or more agent-customer interactions 121; shown in FIG. 1B) are queried 108, for evaluation by the selected one or more evaluators 106, from one or more databases (e.g., an interaction database 122; shown in FIG. 1B) using a search application 109, as shown in FIG. 1A. Specifically, as shown in FIG. 1B, the one or more agent-customer interactions 121 are queried from the interaction database 122—in such embodiments, the search application 109 may be part of the interaction distribution system 119. In one or more embodiments, each of the one or more agent-customer interactions 121 has a corresponding “Segment ID.” “Agent ID,” and “Segment Start Time.”

The queried one or more agent-customer interactions (e.g., the one or more agent-customer interactions 121) form the basis on which one or more evaluation forms are queried 111 from the evaluation form-builder module 110, as shown in FIG. 1A. Specifically, the evaluation form-builder module 110 uses the queried one or more agent-customer interactions (e.g., the one or more agent-customer interactions 121) to query 112 one or more (corresponding) customer questionnaires from one or more databases using a customer feedback application 113 (e.g., Nice Satmetrix). The customer feedback application 113 is part of a customer feedback system 123 (shown in FIG. 1B). In one or more embodiments, the customer feedback system 123 is or includes the one or more databases from which the one or more customer questionnaires are queried. The one or more evaluation forms are then generated (on the fly) by the evaluation form-builder module 110 based on customer feedback contained in the queried one or more customer questionnaires, as shown in FIG. 1A. In this manner, the evaluation form-builder module 110 automatically (re) designs evaluation (i.e., scoring) criteria based on inputs (i.e., feedback) provided by customers, thereby avoiding the manual intervention previously required from managers, supervisors, and/or quality-assurance teams (i.e., to design and maintain a huge list of evaluation forms).

The evaluation form-builder module 110 (shown in FIG. 1A) may be part of the customer feedback system 123 (shown in FIG. 1B)—in such embodiments, the one or more evaluation forms are generated by the evaluation form-builder module 110 in the customer feedback system 123 before being communicated to the interaction distribution system 119. Alternatively, the evaluation form-builder module 110 may be part of the interaction distribution system 119 (shown in FIG. 1B)—in such embodiments, the customer feedback system 123 communicates the queried one or more customer questionnaires to the interaction distribution system 119, and the one or more evaluation forms are generated by the evaluation form-builder module 110 in the interaction distribution system 119.

An evaluation request 114, including the one or more agent-customer interactions together with the one or more evaluation forms generated by the evaluation form-builder module 110, is then stored in one or more databases (e.g., one or more evaluation task assignment databases 125; shown in FIG. 1B) before being communicated to each of the selected one or more evaluators 106, as shown in FIG. 1A. Specifically, one or more evaluation requests 124 (e.g., the evaluation request 114) communicated from the interaction distribution system 119 may be stored in the evaluation task assignment database 125 before being communicated to each of the selected one or more evaluators 106, as shown in FIG. 1B. In one or more embodiments, each of the one or more evaluation requests 124 has a corresponding “Plan Occurrence ID” (denoting the run time of a given calibration plan, which can be weekly, monthly, or one time), “Evaluator ID” (denoting the unique ID of the evaluator), “Segment ID(s)” (denoting the unique ID of the agent call or interaction handled), “Agent ID(s)” (denoting the unique ID of the agent), and “Evaluation Form(s)” (denoting the feedback form provided to the evaluators). After each of the selected one or more evaluators 106 complete the one or more evaluation forms to which they have been assigned, the completed one or more evaluation forms are communicated to the calibration calculation module 115, as shown in FIG. 1A.

The entire flow of information within the system 100 can be divided into three (3) categories, namely a data preparation stage, a data collection stage, and a data processing stage. The data preparation stage utilizes the calibration initiation module 104 (shown in FIG. 1A) to help a manager or supervisor create a calibration configuration in which the filters 107 for distributing agent recordings can be selected, such as: call length of recording; type of channel (voice, chat, email, or any digital channel); call direction (inbound, outbound); call sentiment; the like, or any combination thereof. After defining the filter criteria 107, a manager can select a group of agent teams, a duration over which recorded interactions will be distributed, and the list of evaluators 106 on which the recorded interactions will be provided for the purpose of calibration. Modifiable default groups, durations, and/or lists of the foregoing can also be provided automatically. Specifically, as shown in FIG. 1A, the manager selects some evaluators 106 and filter criteria 107 for which the calibration process can be initiated. In one or more embodiments, the data structure of the calibration initiation request is a complex JSON, which will be explained in further detail below.

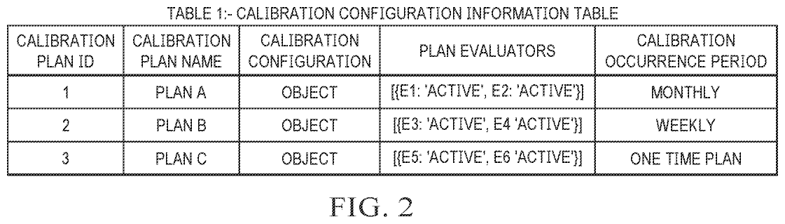

Referring to FIG. 2, with continuing reference to FIGS. 1A-1B, the data structure of the calibration configuration is stored in a table-oriented database. Specifically, Table 1 in FIG. 2 includes the following: a “Calibration Plan ID,” which is a unique ID for every calibration plan created by the manager or supervisor; a “Calibration Plan Name,” which is a unique name for the plan; a “Calibration Configuration,” which is a JSON object, which will be explained in further detail below; and a “Calibration Occurrence Period,” which is the occurrence of the calibration, which can be monthly, weekly, or one time. A monthly calibration occurrence period results in a recorded agent interaction being picked for every month and submitted to the evaluator on a monthly basis. Once a new period starts, a new occurrence of the calibration plan starts so that a monthly agent report regarding the handling of interactions can be recorded. Similarly, a weekly calibration occurrence period results in the recorded agent interaction being sent to the evaluators on a weekly basis, and, once the given week is completed, a new occurrence starting. Finally, a one-time calibration occurrence results from a supervisor or manager configuring a once time plan request in which the select the date range from which the segment of the recorded interactions will be picked.

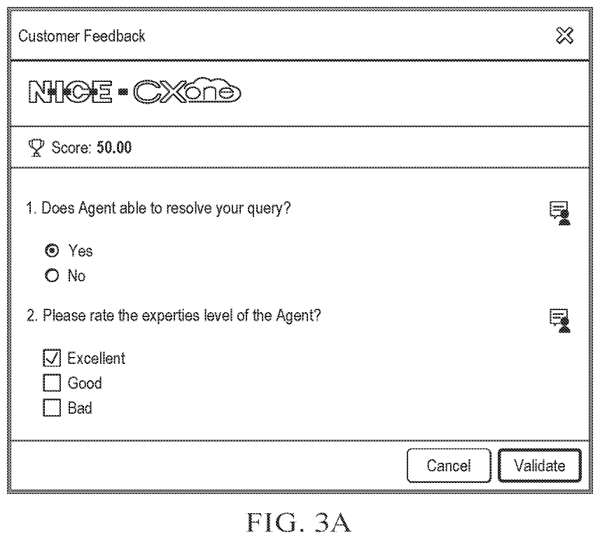

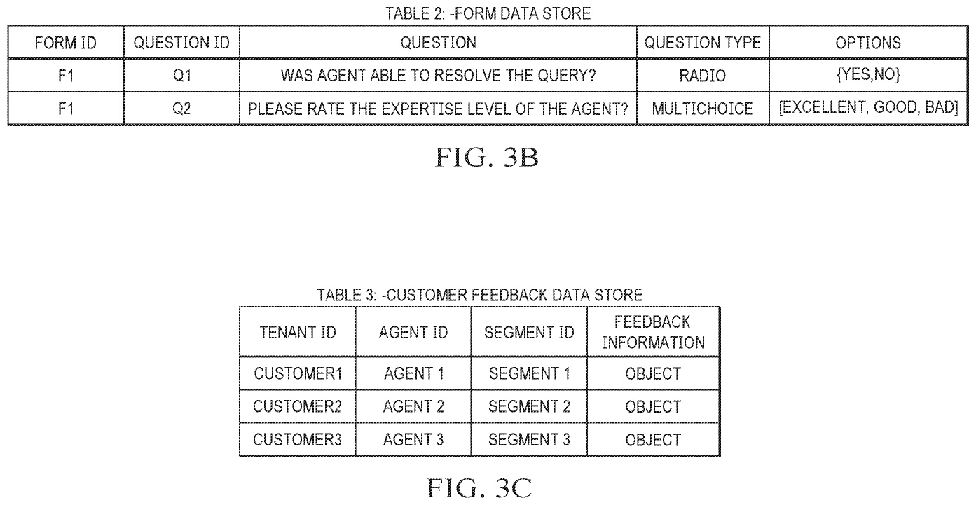

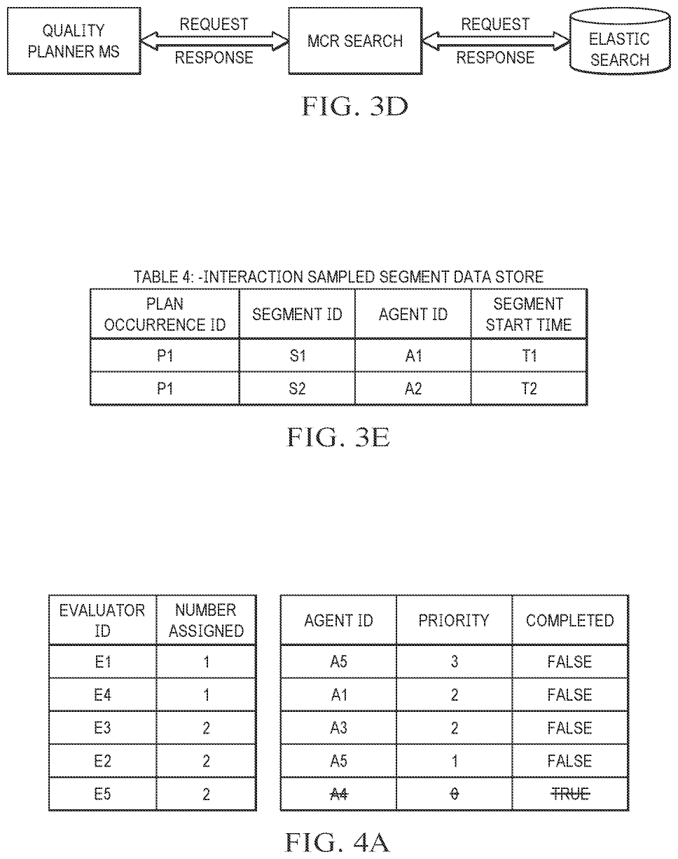

Referring to FIGS. 3A through 3E, with continuing reference to FIGS. 1A through 2, the data collection stage utilizes the customer feedback application 113 (shown in FIG. 1A), which stores customer feedback for each agent-customer interaction. For example, the customer can provide feedback based on questions asked in a survey. An example user interface relating to a customer feedback question asked is shown in FIG. 3A; the illustrated feedback form allows the customer to answer and rate the agent on any given scale. The information feedback form can then be stored in a form database, as shown in FIG. 3B. Specifically, Table 2 in FIG. 3B includes the following: a “Form ID.” which is a unique ID of the feedback form; a “Question ID,” which is a unique ID associated with the give question in the form; a “Question,” which is a string value of the question; a “Question Type,” which denoted the type of option associated with the question (e.g., radio buttons, multiple choice, descriptive question, etc.); and “Option,” which denotes the option selected for the given question.

Information relating to customer feedback can be stored in a customer feedback database, as shown in FIG. 3C. Specifically, Table 3 in FIG. 3C includes the following: a “Tenant ID,” which is a unique ID of the customer who provided the feedback; an “Agent ID,” which is a unique ID of the agent involved with the customer to resolve the query; a “Segment ID,” which is a unique ID of the recording saved; and “Feedback Information,” which is a complex JSON object that is stored, which explains what the answer and score provided by the customer were for the given question, and which will be explained in further detail below.

Further, the data collection stage utilizes the evaluation form-builder module 110, which gets the customer feedback retrieved from the customer feedback application 113. For example, in one or more embodiments, a rest API call is made to the customer feedback application 113 to help get the customer feedback data—the format of the API payload is as follows: REST END POINT:—POST {domainUrl}/customerFeedback; Request Payload:—{agentId: ‘Agent1’, recordingSegmentId: ‘Segment1’}; and Response Object:—the response object will be a JSON response which can be as follows:—“feedback Data”: [{“Question uuid”: “d675691f-97b7-46c4-af55-5b1660c88207”, “type”: “question”, “score”: 1, “answer”: “1”}, {“Question uuid”: “1d9780db-9c5c-480f-a080-c8dd6ddc415c”, “type”: “question”, “score”: 1, “answer”: [“1”].}]

Finally, the data collection stage utilizes a search application, schematically illustrated in FIG. 3D. Specifically, a quality planner microservice of the interaction distribution system may be used to distribute segments across evaluators as per the configuration of the calibration plan. For example, the scheduled job may run according to the configurable duty cycle and distribute the segments evenly among all evaluators. Then, when a manager creates a new calibration plan, the quality planner microservice calls an MCR search microservice, which, in turn, queries elastic search to get the segment records of the agent as per the date range. Once the agent segments are retrieved from elastic search, they are inserted into an interaction sampled segment database, as shown in FIG. 3E. Specifically, Table 4 in FIG. 3E includes the following: a “Plan Occurrence ID,” which is a unique ID for the plan created by the manager or supervisor; a “Segment ID,” which denotes the call segment handled between the agent and customer; an “Agent ID,” which denotes the agent's unique ID; and a “Segment Start Time,” which denotes the time when the agent handled the given call segment. The interaction distribution system can then retrieve such segments from the sampled table (e.g., Table 4) and assign tasks to evaluators, as shown in FIG. 1B.

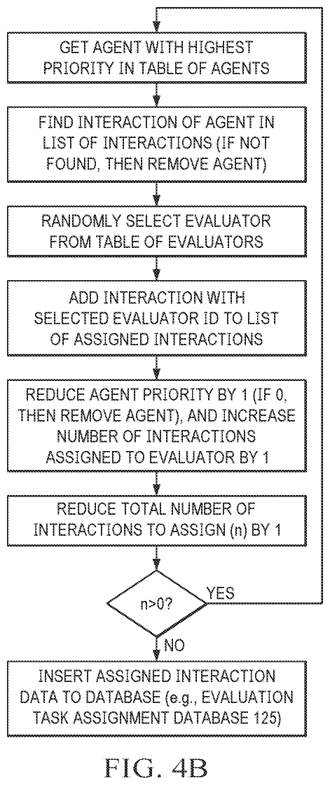

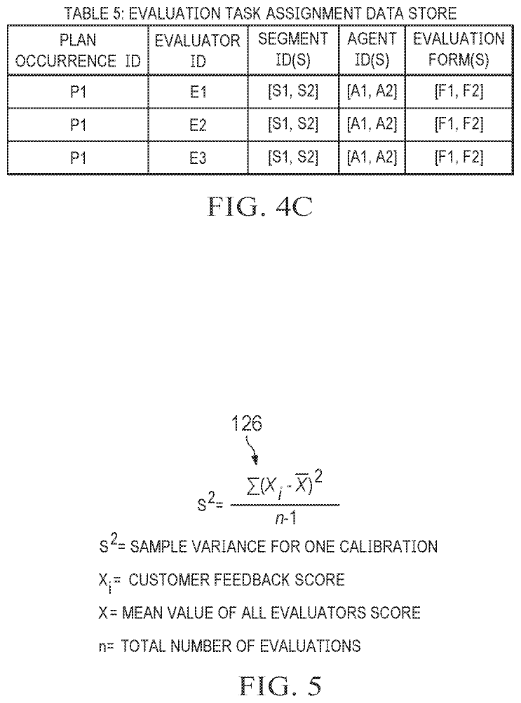

Referring to FIGS. 4A through 4C, with continuing reference to FIGS. 1A through 3E, the data processing stage provides the collected data to the evaluators 106 (as shown in FIG. 1A). Specifically, input data for an assignment phase of the data processing stage includes a total number of interactions (n) to be assigned to each agent and distributed to each evaluator. Evaluators with a lower number of segments assigned have higher priority, whereas agents with the greatest number of segments to be distributed will have higher priority, as shown in FIG. 4A. For example, if the total number of interactions to assign is four (4) per agent, then unless and until a particular agent has completed all interactions, the completion flag associated with than agent will be set to false. Moreover, as shown in the evaluator list, evaluators with the lowest number of assigned interactions (i.e., E1, E4) will be selected for priority distribution of completed interactions.

The agent segment assignment phase is illustrated in FIG. 4B according to one or more embodiments of the present disclosure. The priority of segments is initially stored as n (e.g., consider four (4) if the manager decides to distribute four (4) segments per agent) in the agent table, which means that currently no agent segment need be distributed for the given calibration plan. As and when the agent segment is distributed and assigned to the evaluators, the priority of the agent in the agent table is decremented and the priority of the corresponding evaluator in the evaluator table is incremented (meaning that the evaluator is receiving the task). The loop will continue running until and unless a segment needs to be distributed for the given calibration plan. The selection of the evaluator is generally decided based on which evaluator has received a lower number of tasks; the lowermost number of segments that have been assigned to that evaluator means that said evaluator should be given highest priority for distribution of the next segment to ensure that plan load can be evenly distributed among all of the evaluators. Once all of the given segment(s) are distributed for a particular agent, that agent's priority will be set as zero flagged as completed. Once the entire assignment loop has been completed, the interaction distribution system will store the information to the task assignment database, as shown in FIG. 4C. Specifically, Table 5 in FIG. 4C includes the following: a “Plan Occurrence ID,” which is a unique ID denoting the run time of a given calibration plan that can be weekly, monthly, or a different pre-selected time; an “Evaluator ID.” which is a unique ID of the evaluator; a “Segment ID.” which is a unity ID of the agent call or interaction handled; an “Agent ID,” which is a unique ID of the agent; and “Evaluation Forms,” which denotes the feedback form to be provided to the evaluators for the purpose of evaluation. The data store illustrated in FIG. 4C explains a given calibration plan for three (3) evaluators (i.e., E1, E2, and E3).

Referring to FIG. 5, with continuing reference to FIGS. 1A-1B, in one or more embodiments, the calibration calculation module 115 calculates a customer feedback variance score 126 for the selected evaluator(s) 106 by comparing evaluator feedback contained in the one or more completed evaluation forms to customer feedback in the one or more customer questionnaires. The customer feedback variance score 126 helps the organization understand overall agent performance in handling customer calls-more particularly, it is used to gauge the effectiveness of evaluation as compared to customer feedback. A higher customer feedback variance score 126 results from relatively less effective evaluation. Conversely, a lower customer feedback variance score 126 results from relatively more effective evaluation.

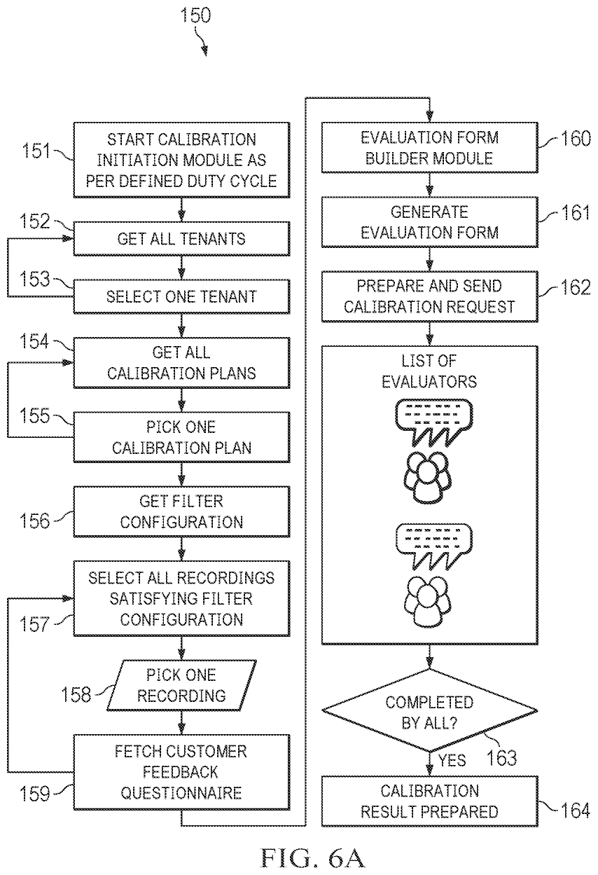

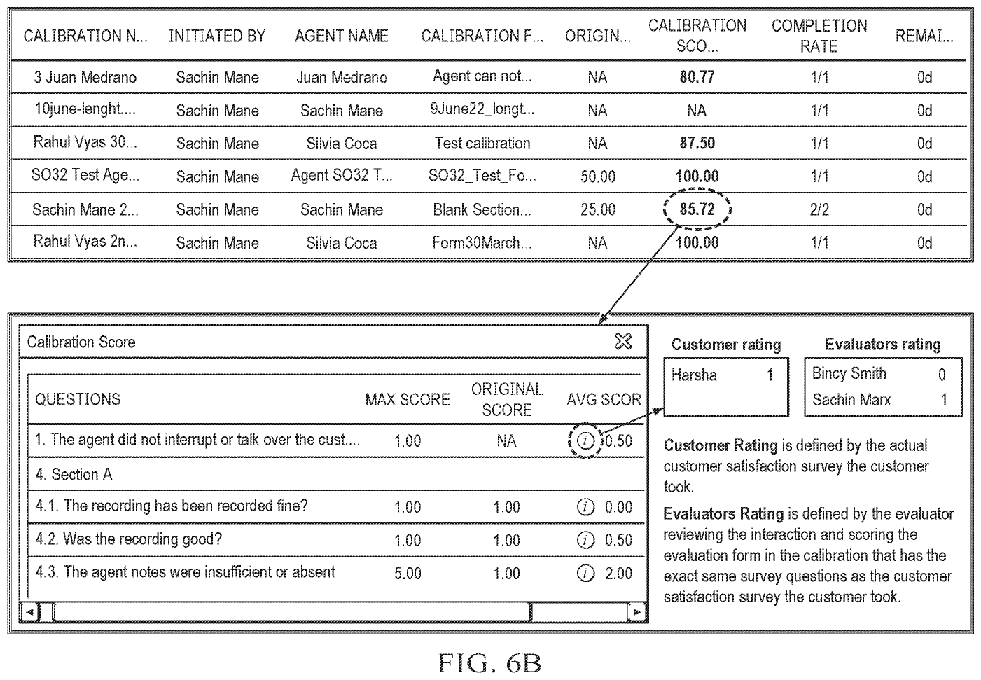

Referring to FIGS. 6A and 6B, with continuing reference to FIGS. 1A through 5, an algorithm 150 for sending calibration(s) to the list of evaluators is illustrated according to one or more embodiments. Once a calibration is initiated (at a step 151) from the calibration initiation module 104 (shown in FIG. 1A) as per the defined duty cycle (a period in which the calibration initiation module 104 will run periodically), the system 100 gets all the available tenants (at a step 152) out of which a single tenant is picked recursively (at a step 153) to initiate automated calibrations. After a tenant is chosen, all the calibration plan details are fetched from the database (at a step 154), and a single plan is chosen recursively (at a step 155) for further processing. Recording filter configuration details (such as the call duration, channel type information, skills filters etc.) are extracted (at a step 156) from the plan details and all the recordings which match the filter configuration are picked (at a step 157) from the interaction database 122. Next, a recursive process of picking up each recording (at a step 158) and fetching the customer feedback questionnaire used in each recording (at a step 159) begins. The process collects all of the valid customer feedback questions from the recordings and passes them on to the evaluation form-builder module 110 (at a step 160). The evaluation form-builder module 110 is responsible for merging all the valid and appropriate questions received from the customer feedback questionnaire and creating an evaluation form (at a step 161) which now contains all the questions laid out by the customer. At a step 162, a calibration request is then prepared with the evaluation form built by the evaluation form-builder module 110 and sent out to all the evaluators configured in the calibration plan. Once the all the evaluators have completed the evaluation from their end (at a step 163), a comparative calibration report (shown in FIG. 6B) is created (at a step 164), which shows the variance in the evaluators score. The comparative calibration report allows the manager or supervisor to conduct a comparative analysis for each question and answer provided by the evaluators against the customer to check for variations.

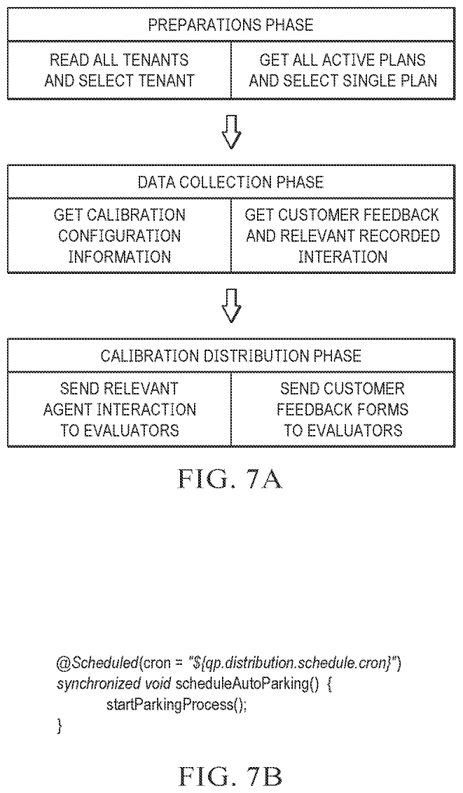

Referring to FIGS. 7A through 7B, with continuing reference to FIGS. 1A through 6B, the entire life-cycle of the algorithm 150 is illustrated according to one or more embodiments of the present disclosure. The life-cycle includes the preparation phase, the data collection phase, and the calibration distribution phase, as shown in FIG. 7A and discussed herein. In one or more embodiments, the entire life-cycle process can be run and scheduled via a cron-job application according to the example shown in FIG. 7B. Specifically, the “@Scheduled” annotation is used to trigger the scheduler for a specified time period. Additionally, “qp.distribution.schedule.cron” can be kept inside the configuration file which will define the time period after which the same process should be repeated. For example, the following is a sample expression that shows how to execute the task every minute starting at 9:00 AM and ending at 9:59 AM, every day: qp.distribution.schedule.cron=“0*9**?”.

In one or more embodiments, the preparation phase may include calling the relevant REST API to get all tenant IDs available for a given business unit. The API format can be as follows: REST END POINT:—GET {domainUrl}/tenants; Request Payload:—{status: “ACTIVE”}; and Response Object:—{tenants: [{tenantId: 1, name: NICE}, {tenantId: 2, name: IBM}]}. Specifically, the rest end-point is called with the request payload in which a list of all of the active tenants are fetched. The response object provides a list of tenants; from here, one tenant is picked every scheduled time until the entire list has been iterated over. Furthermore, the preparation phase may include getting all active plans by picking all active plans from the table-oriented database (shown in FIG. 2) associated with the selected tenant. Specifically, the active plans and relevant parking configuration are saved inside the table-oriented database in the manner illustrated in FIG. 2. Indeed, since the active plan information shown in FIG. 2 belongs to a given tenant schema, querying the table-oriented database will yield all of the active plans saved for the given tenant. Moreover, the calibration configuration can be configured as an object for the given calibration plan.

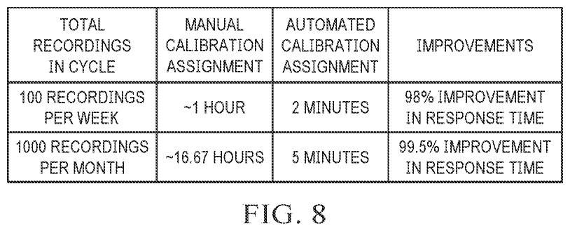

Referring to FIG. 8, with continuing reference to FIGS. 1A through 7B, an improvement in response time provided by the system 100 is illustrated according to one or more embodiments of the present disclosure. For example, when a manual calibration of 100 recordings per week is assigned to the evaluators, it takes approximately 1 hour. On the other hand, the automated calibration assignment provided by the system 100 takes approximately 2 minutes, resulting in a performance improvement of approximately 98%. Similarly, increasing the load per month to 1000 recordings results in a 99.5% improvement from approximately 16.67 hours for manual calibration to approximately 5 minutes for the automated calibration assignment provided by the system 100. A reduction in evaluator fatigue from a monotonous workload, and the error rate that typically accompanies such increasing fatigue, are additional advantages that may be achieved through the present disclosure.

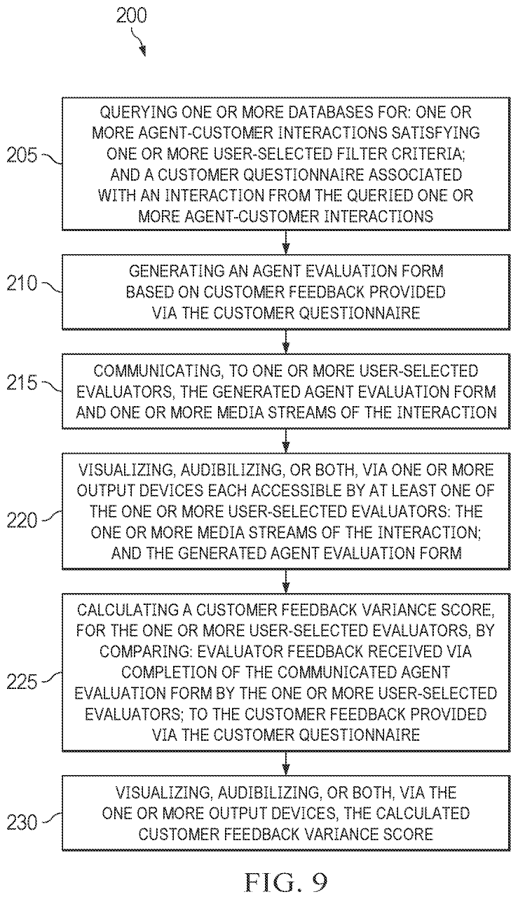

Referring to FIG. 9, with continuing reference to FIGS. 1A through 8, a method 200 for calibrating evaluator feedback relating to agent-customer interaction(s) based on corresponding customer feedback is illustrated according to one or more embodiments of the present disclosure. In one or more embodiments, the method 200 is executed by the system 100. The method 200 includes, at a step 205, querying one or more databases for: one or more agent-customer interactions satisfying the one or more selected filter criteria; and a customer questionnaire associated with an interaction from the queried one or more agent-customer interactions. At a step 210, an agent evaluation form is generated based on customer feedback provided via the customer questionnaire. At a step 215, the generated agent evaluation form is communicated, together with one or more media streams of the interaction, to one or more user-selected evaluators. At a step 220, the one or more media streams of the interaction and the generated agent evaluation form are visualized, audibilized, or both, via one or more output devices each accessible by at least one of the one or more user-selected evaluators. At a step 225, a customer feedback variance score is calculated, for the one or more user-selected evaluators, by comparing: evaluator feedback received via completion of the communicated agent evaluation form by the one or more user-selected evaluators; to the customer feedback provided via the customer questionnaire. Finally, at a step 230, the calculated customer feedback variance score is visualized, audibilized, or both, via the one or more output devices.

The present disclosure provides an automated way of initiating a calibration for the one or more agent-customer interactions while avoiding the need for manual intervention by the manager and supervisor. Indeed, using the system 100 by for example, executing the method 200, helps the manager and supervisor by saving time and increasing efficiency. Utilization of the one or more customer feedback questionnaires by the evaluation form-builder module 110 avoids the organizational cost of maintaining a huge list of evaluation forms on which calibration must be performed. Calculating the customer feedback variance score for each of the one or more evaluators, based on the one or more customer feedback questionnaires, helps to ensure that evaluator feedback is aligned with actual customer feedback. The present disclosure provides each agent with relatively quick calibrated feedback from the one or more evaluators, and reduces delays previously associated with the coaching assignment process. For example, the present disclosure reduces the time it takes to manually find the “right” interactions to calibrate, and to manually assign the calibration.

The automation of calibrations according to the present disclosure also pulls in specific interactions that surveyed for customer feedback and utilizes the actual customer survey as the “original” evaluation; thus, the customer survey becomes the benchmark used to assess calibration variance of calibration participants. As a result, interactions calibrated by evaluators and supervisors are strategically aligned with current customer defect scores, which also improves the scoring of interactions not attached to a survey. Since supervisors participate in calibrations no less than every other week, the present disclosure drives improvements in coaching effectiveness to quality criteria, thereby aligning with the quality team. Finally, the present disclosure reduces potential internal business strife by mitigating the “us vs. them” mentality that can often arise between agents and evaluators. Aligning the scoring and coaching expectations of a supervisor drives the same message between both teams to the agent. This teamwork approach provides the agent with more faith in the quality program and how they are scored, and can provide more objective results than manual calibration by evaluator(s), therefore improving how agents tend to perform in quality, which impacts overall contact center performance.

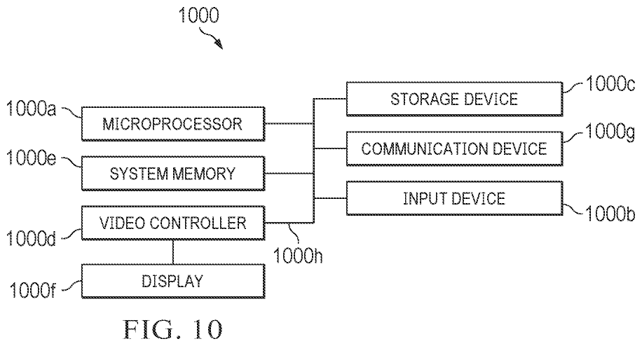

Referring to FIG. 10, with continuing reference to FIGS. 1A through 9, an illustrative node 1000 for implementing one or more of the embodiments described above and/or illustrated in FIGS. 1A through 9 is depicted, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), component(s), or any combination thereof.

The node 1000 includes a microprocessor 1000a, an input device 1000b, a storage device 1000c, a video controller 1000d, a system memory 1000e, a display 1000f, and a communication device 1000g all interconnected by one or more buses 1000h. In one or more embodiments, the storage device 1000c may include a hard drive, CD-ROM, optical drive, any other form of storage device and/or any combination thereof. In one or more embodiments, the storage device 1000c may include, and/or be capable of receiving, a CD-ROM, DVD-ROM, or any other form of non-transitory computer-readable medium that may contain executable instructions. In one or more embodiments, the communication device 1000g may include a modem, network card, or any other device to enable the node 1000 to communicate with other node(s). In one or more embodiments, the node and the other node(s) represent a plurality of interconnected (whether by intranet or Internet) computer systems, including without limitation, personal computers, mainframes, PDAS, smartphones and cell phones.

In one or more embodiments, one or more of the embodiments described above and/or illustrated in FIGS. 1A through 9 include at least the node 1000 and/or components thereof, and/or one or more nodes that are substantially similar to the node 1000 and/or components thereof. In one or more embodiments, one or more of the above-described components of the node 1000 and/or the embodiments described above and/or illustrated in FIGS. 1A through 9 include respective pluralities of same components.

In one or more embodiments, one or more of the embodiments described above and/or illustrated in FIGS. 1A through 9 include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in one or more embodiments pulls real-time information from one or more servers, automatically refreshing with latest information at a predetermined time increment; or any combination thereof.

In one or more embodiments, a computer system typically includes at least hardware capable of executing machine readable instructions, as well as the software for executing acts (typically machine-readable instructions) that produce a desired result. In one or more embodiments, a computer system may include hybrids of hardware and software, as well as computer sub-systems.

In one or more embodiments, hardware generally includes at least processor-capable platforms, such as client-machines (also known as personal computers or servers), and hand-held processing devices (such as smart phones, tablet computers, or personal computing devices (PCDs), for example). In one or more embodiments, hardware may include any physical device that is capable of storing machine-readable instructions, such as memory or other data storage devices. In one or more embodiments, other forms of hardware include hardware sub-systems, including transfer devices such as modems, modem cards, ports, and port cards, for example.

In one or more embodiments, software includes any machine code stored in any memory medium, such as RAM or ROM, and machine code stored on other devices (such as floppy disks, flash memory, or a CD-ROM, for example). In one or more embodiments, software may include source or object code. In one or more embodiments, software encompasses any set of instructions capable of being executed on a node such as, for example, on a client machine or server.

In one or more embodiments, combinations of software and hardware could also be used for providing enhanced functionality and performance for certain embodiments of the present disclosure. In an embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In one or more embodiments, computer readable mediums include, for example, passive data storage, such as a random-access memory (RAM) as well as semi-permanent data storage such as a compact disk read only memory (CD-ROM). One or more embodiments of the present disclosure may be embodied in the RAM of a computer to transform a standard computer into a new specific computing machine. In one or more embodiments, data structures are defined organizations of data that may enable an embodiment of the present disclosure. In an embodiment, a data structure may provide an organization of data, or an organization of executable code.

In one or more embodiments, any networks and/or one or more portions thereof may be designed to work on any specific architecture. In an embodiment, one or more portions of any networks may be executed on a single computer, local area networks, client-server networks, wide area networks, internets, hand-held and other portable and wireless devices and networks.

In one or more embodiments, a database may be any standard or proprietary database software. In one or more embodiments, the database may have fields, records, data, and other database elements that may be associated through database specific software. In one or more embodiments, data may be mapped. In one or more embodiments, mapping is the process of associating one data entry with another data entry. In an embodiment, the data contained in the location of a character file can be mapped to a field in a second table. In one or more embodiments, the physical location of the database is not limiting, and the database may be distributed. In an embodiment, the database may exist remotely from the server, and run on a separate platform. In an embodiment, the database may be accessible across the Internet. In one or more embodiments, more than one database may be implemented.

In one or more embodiments, a plurality of instructions stored on a non-transitory computer readable medium may be executed by one or more processors to cause the one or more processors to carry out or implement in whole or in part one or more of the embodiments described above and/or illustrated in FIGS. 1A through 9, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), component(s), or any combination thereof. In one or more embodiments, such a processor may include one or more of the microprocessor 1000a, any processor(s) that is/are part of one or more of the embodiments described above and/or illustrated in FIGS. 1A through 9, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), or component(s), and/or any combination thereof, and such a computer readable medium may be distributed among one or more components of the system. In one or more embodiments, such a processor may execute the plurality of instructions in connection with a virtual computer system. In one or more embodiments, such a plurality of instructions may communicate directly with the one or more processors, and/or may interact with one or more operating systems, middleware, firmware, other applications, and/or any combination thereof, to cause the one or more processors to execute the instructions.

An apparatus for calibrating evaluator feedback relating to one or more agent-customer interactions based on corresponding customer feedback has been disclosed. In one or more embodiments, the apparatus includes one or more non-transitory computer readable media and a plurality of instructions stored on the one or more non-transitory computer readable media and executable by one or more processors to implement operations including: querying one or more databases for: one or more agent-customer interactions satisfying one or more user-selected filter criteria; and a customer questionnaire associated with an interaction from the queried one or more agent-customer interactions; generating an agent evaluation form based on customer feedback provided via the customer questionnaire; communicating, to one or more user-selected evaluators, the generated agent evaluation form and one or more media streams of the interaction; visualizing, audibilizing, or both, via one or more output devices each accessible by at least one of the one or more user-selected evaluators: the one or more media streams of the interaction; and the generated agent evaluation form; and calculating a customer feedback variance score, for the one or more user-selected evaluators, by comparing: evaluator feedback received via completion of the communicated agent evaluation form by the one or more user-selected evaluators; to the customer feedback provided via the customer questionnaire. In one or more embodiments, the operations further include visualizing, audibilizing, or both, via the one or more output devices, the calculated customer feedback variance score. In one or more embodiments, the one or more user-selected filter criteria include channel type, duration of interaction, customer scoring of interaction, customer sentiment during interaction, or any combination thereof. In one or more embodiments, the operations further include querying the one or more databases for one or more additional customer questionnaires associated with one or more additional interactions from the queried one or more customer-agent interactions. In one or more embodiments, generating the agent evaluation form is further based on customer feedback provided via the one or more additional customer questionnaires. In one or more embodiments, the operations further include: communicating to the one or more user-selected evaluators, one or more additional media streams of the one or more additional interactions; and visualizing, audibilizing, or both, via the one or more output devices, the one or more additional media streams. In one or more embodiments, the customer feedback variance score is calculated, for the one or more user-selected evaluators, by further comparing: the evaluator feedback received via completion of the communicated agent evaluation form by the one or more user-selected evaluators; to the customer feedback provided via the one or more additional customer questionnaires.

A system for calibrating evaluator feedback relating to one or more agent-customer interactions based on corresponding customer feedback has also been disclosed. In one or more embodiments, the system includes: one or more databases; one or more computing devices adapted to: query the one or more databases for: one or more agent-customer interactions satisfying one or more user-selected filter criteria; and a customer questionnaire associated with an interaction from the queried one or more agent-customer interactions; generate an agent evaluation form based on customer feedback provided via the customer questionnaire; communicate, to one or more user-selected evaluators, the generated agent evaluation form and one or more media streams of the interaction; and calculate a customer feedback variance score for the one or more user-selected evaluators by comparing: evaluator feedback received via completion of the communicated agent evaluation form by the one or more user-selected evaluators; to the customer feedback provided via the customer questionnaire; and one or more output devices each accessible by at least one of the one or more user-selected evaluators, and adapted to visualize, audibilize, or both: the one or more media streams of the interaction; and the generated agent evaluation score. In one or more embodiments, the one or more output devices are further adapted to visualize, audibilize, or both, the calculated customer feedback variance score. In one or more embodiments, the one or more user-selected filter criteria include channel type, duration of interaction, customer scoring of interaction, customer sentiment during interaction, or any combination thereof. In one or more embodiments, the one or more computing devices are further adapted to query the one or more databases for one or more additional customer questionnaires associated with one or more additional interactions from the queried one or more customer-agent interactions. In one or more embodiments, the one or more computing devices are adapted to generate the agent evaluation form further based on customer feedback provided via the one or more additional customer questionnaires. In one or more embodiments, the one or more computing devices are further adapted to communicate, to the one or more user-selected evaluators, one or more additional media streams of the one or more additional interactions; and wherein the one or more output devices are further adapted to visualize, audibilize, or both, the one or more additional media streams. In one or more embodiments, the one or more computing devices are adapted to calculate the customer feedback variance score for the one or more user-selected evaluators by further comparing: the evaluator feedback received via completion of the communicated agent evaluation form by the one or more user-selected evaluators; to the customer feedback provided via the one or more additional customer questionnaires.

A method for calibrating evaluator feedback relating to one or more agent-customer interactions based on corresponding customer feedback has also been disclosed. In one or more embodiments, the method includes: querying one or more databases, using one or more computing devices, for: one or more agent-customer interactions satisfying one or more user-selected filter criteria; and a customer questionnaire associated with an interaction from the queried one or more agent-customer interactions; generating an agent evaluation form, using the one or more computing devices, based on customer feedback provided via the customer questionnaire; communicating, to one or more user-selected evaluators using the one or more computing devices, the generated agent evaluation form and one or more media streams of the interaction; visualizing, audibilizing, or both, via one or more output devices each accessible by at least one of the one or more user-selected evaluators: the one or more media streams of the interaction; and the generated agent evaluation form; and calculating a customer feedback variance score, using the one or more computing devices, for the one or more user-selected evaluators, by comparing: evaluator feedback received via completion of the communicated agent evaluation form by the one or more user-selected evaluators; to the customer feedback provided via the customer questionnaire. In one or more embodiments, the method further includes visualizing, audibilizing, or both, via the one or more output devices, the calculated customer feedback variance score. In one or more embodiments, the one or more user-selected filter criteria include channel type, duration of interaction, customer scoring of interaction, customer sentiment during interaction, or any combination thereof. In one or more embodiments, the method further includes querying the one or more databases, using the one or more computing devices, for one or more additional customer questionnaires associated with one or more additional interactions from the queried one or more customer-agent interactions. In one or more embodiments, generating the agent evaluation form, using the one or more computing devices, is further based on customer feedback provided via the one or more additional customer questionnaires. In one or more embodiments, the method further includes: communicating to the one or more user-selected evaluators, using the one or more computing devices, one or more additional media streams of the one or more additional interactions; and visualizing, audibilizing, or both, via the one or more output devices, the one or more additional media streams. In one or more embodiments, the customer feedback variance score is calculated, using the one or more computing devices, by further comparing: the evaluator feedback received via completion of the communicated agent evaluation form by the one or more user-selected evaluators; to the customer feedback provided via the one or more additional customer questionnaires.

It is understood that variations may be made in the foregoing without departing from the scope of the present disclosure.

In one or more embodiments, the elements and teachings of the various embodiments may be combined in whole or in part in some (or all) of the embodiments. In addition, one or more of the elements and teachings of the various embodiments may be omitted, at least in part, and/or combined, at least in part, with one or more of the other elements and teachings of the various embodiments.

In one or more embodiments, while different steps, processes, and procedures are described as appearing as distinct acts, one or more of the steps, one or more of the processes, and/or one or more of the procedures may also be performed in different orders, simultaneously and/or sequentially. In one or more embodiments, the steps, processes, and/or procedures may be merged into one or more steps, processes and/or procedures.

In one or more embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although various embodiments have been described in detail above, the embodiments described are illustrative only and are not limiting, and those of ordinary skill in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112 (f) for any limitations of any of the claims herein, except for those in which the claim expressly uses the word “means” together with an associated function.

What is claimed is:

1. An apparatus for calibrating evaluator feedback relating to one or more agent-customer interactions based on corresponding customer feedback, which comprises one or more non-transitory computer readable media and a plurality of instructions stored on the one or more non-transitory computer readable media and executable by one or more processors to implement operations comprising:
querying one or more databases for:
one or more agent-customer interactions satisfying one or more user-selected filter criteria; and
a customer questionnaire associated with an interaction from the queried one or more agent-customer interactions;
generating an agent evaluation form based on customer feedback provided via the customer questionnaire;
communicating, to one or more user-selected evaluators, the generated agent evaluation form and one or more media streams of the interaction;
visualizing, audibilizing, or both, via one or more output devices each accessible by at least one of the one or more user-selected evaluators:
the one or more media streams of the interaction; and
the generated agent evaluation form; and
calculating a customer feedback variance score, for the one or more user-selected evaluators, by comparing:
evaluator feedback received via completion of the communicated agent evaluation form by the one or more user-selected evaluators; to
the customer feedback provided via the customer questionnaire.

2. The apparatus of claim 1, wherein the operations further comprise visualizing, audibilizing, or both, via the one or more output devices, the calculated customer feedback variance score.

3. The apparatus of claim 1, wherein the one or more user-selected filter criteria comprise channel type, duration of interaction, customer scoring of interaction, customer sentiment during interaction, or any combination thereof.

4. The apparatus of claim 1, wherein the operations further comprise querying the one or more databases for one or more additional customer questionnaires associated with one or more additional interactions from the queried one or more customer-agent interactions.

5. The apparatus of claim 4, wherein generating the agent evaluation form is further based on customer feedback provided via the one or more additional customer questionnaires.

6. The apparatus of claim 5, wherein the operations further comprise:
communicating to the one or more user-selected evaluators, one or more additional media streams of the one or more additional interactions; and
visualizing, audibilizing, or both, via the one or more output devices, the one or more additional media streams.

7. The apparatus of claim 6, wherein the customer feedback variance score is calculated, for the one or more user-selected evaluators, by further comparing:
the evaluator feedback received via completion of the communicated agent evaluation form by the one or more user-selected evaluators; to
the customer feedback provided via the one or more additional customer questionnaires.

8. A system for calibrating evaluator feedback relating to one or more agent-customer interactions based on corresponding customer feedback, which comprises:
one or more databases;
one or more computing devices adapted to:
query the one or more databases for:
one or more agent-customer interactions satisfying one or more user-selected filter criteria; and
a customer questionnaire associated with an interaction from the queried one or more agent-customer interactions;
generate an agent evaluation form based on customer feedback provided via the customer questionnaire;
communicate, to one or more user-selected evaluators, the generated agent evaluation form and one or more media streams of the interaction; and
calculate a customer feedback variance score for the one or more user-selected evaluators by comparing:
evaluator feedback received via completion of the communicated agent evaluation form by the one or more user-selected evaluators; to
the customer feedback provided via the customer questionnaire;
and
one or more output devices each accessible by at least one of the one or more user-selected evaluators, and adapted to visualize, audibilize, or both:
the one or more media streams of the interaction; and
the generated agent evaluation score.

9. The system of claim 8, wherein the one or more output devices are further adapted to visualize, audibilize, or both, the calculated customer feedback variance score.

10. The system of claim 8, wherein the one or more user-selected filter criteria comprise channel type, duration of interaction, customer scoring of interaction, customer sentiment during interaction, or any combination thereof.

11. The system of claim 8, wherein the one or more computing devices are further adapted to query the one or more databases for one or more additional customer questionnaires associated with one or more additional interactions from the queried one or more customer-agent interactions.

12. The system of claim 11, wherein the one or more computing devices are adapted to generate the agent evaluation form further based on customer feedback provided via the one or more additional customer questionnaires.

13. The system of claim 12, wherein the one or more computing devices are further adapted to communicate, to the one or more user-selected evaluators, one or more additional media streams of the one or more additional interactions; and
wherein the one or more output devices are further adapted to visualize, audibilize, or both, the one or more additional media streams.

14. The system of claim 12, wherein the one or more computing devices are adapted to calculate the customer feedback variance score for the one or more user-selected evaluators by further comparing:
the evaluator feedback received via completion of the communicated agent evaluation form by the one or more user-selected evaluators; to
the customer feedback provided via the one or more additional customer questionnaires.

15. A method for calibrating evaluator feedback relating to one or more agent-customer interactions based on corresponding customer feedback, which comprises:
querying one or more databases, using one or more computing devices, for:
one or more agent-customer interactions satisfying one or more user-selected filter criteria; and
a customer questionnaire associated with an interaction from the queried one or more agent-customer interactions;
generating an agent evaluation form, using the one or more computing devices, based on customer feedback provided via the customer questionnaire;
communicating, to one or more user-selected evaluators using the one or more computing devices, the generated agent evaluation form and one or more media streams of the interaction;
visualizing, audibilizing, or both, via one or more output devices each accessible by at least one of the one or more user-selected evaluators:
the one or more media streams of the interaction; and
the generated agent evaluation form;
and
calculating a customer feedback variance score, using the one or more computing devices, for the one or more user-selected evaluators, by comparing:
evaluator feedback received via completion of the communicated agent evaluation form by the one or more user-selected evaluators; to
the customer feedback provided via the customer questionnaire.

16. The method of claim 15, which further comprises visualizing, audibilizing, or both, via the one or more output devices, the calculated customer feedback variance score.

17. The method of claim 15, wherein the one or more user-selected filter criteria comprise channel type, duration of interaction, customer scoring of interaction, customer sentiment during interaction, or any combination thereof.

18. The method of claim 15, which further comprises querying the one or more databases, using the one or more computing devices, for one or more additional customer questionnaires associated with one or more additional interactions from the queried one or more customer-agent interactions.

19. The method of claim 18, wherein generating the agent evaluation form, using the one or more computing devices, is further based on customer feedback provided via the one or more additional customer questionnaires.

20. The method of claim 19, which further comprises:
communicating to the one or more user-selected evaluators, using the one or more computing devices, one or more additional media streams of the one or more additional interactions; and
visualizing, audibilizing, or both, via the one or more output devices, the one or more additional media streams.

21. The method of claim 20, wherein the customer feedback variance score is calculated, using the one or more computing devices, by further comparing:
the evaluator feedback received via completion of the communicated agent evaluation form by the one or more user-selected evaluators; to
the customer feedback provided via the one or more additional customer questionnaires.
